(19) United States
(12) Patent Application Publication
(10) Pub. No.: US 2004/0091772 A1
(43) Pub. Date: May 13, 2004

(54) Lithium-ion battery electrolytes with improved thermal stability

(76) Inventors: Boris Ravdel, New London, CT (US); Robert Gitzendanner, Westerly, RI (US); Brett Lucht, Wakefield, RI (US); Kuzhikalail M. Abraham, Needham, MA (US)

Correspondence Address: Attorney John R. Doherty, P.O. Box 706, Stevenson, CT, 06491-0706, US

(21) Appl. No.: 10/600,211

(22) Filed: Jun. 20, 2003

Related U.S. Application Data
(60) Provisional application No. 60/390,318, filed on Jun. 20, 2002.

(51) Int. Cl. H01M 10/40

(52) U.S. Cl. 429/188; 429/330; 429/338; 429/342; 429/326; 429/339; 429/340

(57) ABSTRACT

Thermally stable electrolytes for Li-ion batteries obtained with the use of Lewis base additives to the electrolytes are disclosed. The Lewis bases stabilize electrolytes composed of solutions of LiPF₆ in organic carbonates against decomposition at temperatures as high as 85° C. Additives suitable for stabilizing LiPF₆-containing electrolytes include amines, for example, triethylenediamine (TEDA) and 2,2′-bipyridine (BIPY), phosphines, for example, triphenylphosphine (TPP) and tributylphosphine (TBP), and nitrogen-phosphorus bonded compounds such as hexamethoxycyclotriphosphazene ([N═P(OCH₃)₂]₃) (HMOPA), hexamethyl phosphoramide (HMPA), and N-phenyl-P,P,P-trimethylphosphorimidate (PhTMI). These additives are also capable of stabilizing electrolytes in solvents other than carbonates including ethers, esters and sulfones.

### PRIORITIES

This application claims priority to our earlier filed provisional application Ser. No. 60/390,318, filed on Jun. 20, 2002.

### GOVERNMENT RIGHTS

This invention was carried out with the support of the United States Government which has certain rights therein.

### FIELD OF THE INVENTION

This invention relates to high energy density rechargeable lithium batteries, and more particularly to lithium-ion battery electrolytes containing lithium hexafluorophosphate (LiPF₆) solutions in alkyl carbonate solvents which afford improved thermal stability, higher cycling efficiency and longer cycle life, especially at elevated temperatures.

### BACKGROUND OF THE INVENTION

A rechargeable current producing electrochemical cell has to satisfy many requirements in order to be of practical value. Among the requirements is the ability to operate at elevated temperatures for many charge discharge cycles.

One attractive class of modern high energy density rechargeable battery is the Li-ion battery. The principal components of a Li-ion battery are a graphitic carbon anode, for example, natural or artificial graphite, a typical example being mesocarbon microbead (MCMB) carbon,a lithiated transition metal oxide cathode such as LiCoO₂, and a highly conductive electrolyte solution. The electrolyte provides conductivity to the Li ions which are transported from the anode to the cathode, and vice versa, during discharge and charge of the battery. Ideally, the electrolyte solution should be electrochemically and thermally stable over the entire operating temperature range of the battery. If the electrolyte decomposes, particularly consuming Li ions, the performance of the battery would be adversely affected.

The commonly used electrolyte solutions in lithium-ion batteries are composed of solutions of lithium hexafluorophosphate (LiPF₆) in a solvent mixture of two or more organic carbonate solvents, typically the cyclic carbonate ethylene carbonate (EC) and one or more acyclic carbonates selected from dimethyl carbonate (DMC), diethyl carbonate (DEC), ethylmethyl carbonate (EMC), and others of the general formula ROCOOR¹, where R and R¹ are the same or different alkyl groups. These solutions have high ionic conductivity and are electrochemically stable in the voltage window of operation of Li-ion batteries, usually between 0.0 and 4.5V vs. Li/Li^{+.} Unfortunately, the usefulness of these electrolytes is limited to a battery operational as well as a battery storage temperature range where the upper limit is only about +50° C. This is because the electrolytes decompose above this temperature limiting the performance of the battery. Since many practical applications of Li-ion batteries require them to perform at temperatures as high as 85° C., a solution to the thermal instability of LiPF₆-containing electrolytes is essential for the versatile application of Li-ion batteries.

An important object of this invention is therefore to improve the thermal stability of electrolytes used in Li-ion batteries.

Another more specific object is to improve the thermal stability of electrolytes composed of hexafluorophosphate (LiPF₆) solutions in organic carbonate solvents.

### SUMMARY OF THE INVENTION

The invention is directed to non-aqueous electrolytes for use in rechargeable Li-ion batteries comprising a solution of a lithium salt in a non-aqueous organic solvent containing a Lewis base additive. It has been discovered in accordance with the invention that the addition of a Lewis base additive to the non-aqueous electrolyte of a rechargeable Li-ion battery significantly improves the thermal stability of the electrolyte and consequently greatly enhances the cycling efficiency and cycle life of the battery.

The Lewis base additives used in the non-aqueous electrolytes of the invention may be organic amines such as triethylenediamine (TEDA) and 2,2′-bipyridine (BIPY), phosphines such as triphenylphosphine (TPP) and tributylphosphine (TBP) and nitrogen-phosphorus bonded compounds such as hexamethoxycyclotriphosphazene ([N═P(OCH₃)₂]₃) (HMOPA), hexamethylphosphoramide (HMPA), and N-phenyl-P,P,P-trimethylphosphorimidate (PhTMI), for example, as well as mixtures thereof.

The non-aqueous electrolytes of the invention may employ a number of lithium salts such as lithium hexafluorophosphate (LiPF₆), lithium hexafluoroarsenate (LiAsF₆) and lithium tetrafluoroborate (LiBF₄), for example, as well as mixtures thereof. The preferred lithium salt for use in the electrolytes is lithium hexafluorophosphate (LiPF₆). Other lithium salts as well as mixtures of salts may also be useful in the electrolytes of the invention.

Among the organic solvents that may be used in the electrolytes of the invention are the organic carbonates, esters, ethers, glymes, organic nitrites, sulfones as well as mixtures thereof. The organic carbonates are preferred and may be the cyclic organic carbonates such as ethylene carbonate (EC), propylene carbonate (PC), triethylene carbonate (TEC), and isobutylene carbonate (IBC) or the acyclic carbonates such as dimethyl carbonate (DMC), diethyl carbonate (DEC), ethylmethyl carbonate (EMC) and mixtures thereof. The organic solvent for use in the electrolytes may also be a compound of the general formula ROCOOR¹, where R and R¹ are the same or different alkyl groups.

In another aspect, the invention is also directed to an electric current producing rechargeable Li-ion cell comprising an anode; a cathode; and a non-aqueous electrolyte comprising a solution of a lithium salt in a non-aqueous organic solvent containing a Lewis base additive as described hereinabove.

The anode of the Li-ion cell of the invention consists of a lithium intercalating compound such as a carbonaceous material and the cathode consists of a lithium intercalating transition metal compound such as LiCoO₂; LiNiO₂; LiNi₁₋ₓCoₓO₂ where x is 0.3<x<1.0; LiMn₂O₄; LiV₂O₅; LiMₓN₁₋ₓO₂, where M and N are transition metals and x has a value between zero and one; LiFePO₄; LiCrS₂; and LiVS₂, for example.

### BRIEF DESCRIPTION OF THE DRAWINGS

FIG. 1 is a graph showing the conductivities of electrolyte solutions composed of 1M LiPF₆ in EC:EMC (1:3) as a function of storage time at 85° C. wherein amounts of the Lewis base additive HMOPA was varied for different samples (Curve 1: 0 wt. %; Curve 2: 3.0 wt %; Curve 3: 6.1 wt %; Curve 4: 9.1 wt %; and Curve 5: 11.9 wt %);

FIG. 2 is a ¹H Nuclear Magnetic Reonance (NMR) spectrum of 1.0 M LiPF₆ in EC/DMC/DEC (1:1:1) without any added Lewis base before heating (standard spectrum for comparing stored electrolytes);

FIG. 3 is a ¹H NMR pectrum of 1.0 M LiPF₆ in EC/DMC/DEC (1:1:1) without any added Lewis base after heating at 85° C. for 1 week.

FIG. 4 is a graft showing the conductivities of electrolyte solutions of 1M LiPF₆ in EC:DMC:DEC (1:1:1) as a function of storage time at 85° C. wherein amounts of the Lewis base additive HMOPA was varied for different samples (Curve 1: 0 wt. %; Curve 2: 3.0 wt %; Curve 3: 6.1 wt %; Curve 4: 9.1 wt %; and Curve 5: 11.9 wt %);

FIG. 5 is a ¹H NMR spectrum of 1.0 M LiPF₆ in EC/DMC/DEC (1:1:1) with 3.0% by weight of [NP(OCH₃)₂]₃ (HMOPA) after heating for 2 months.

FIG. 6 is a ¹H NMR spectrum of 1.0 M LiPF₆ in EC/DMC/DEC (1:1:1) with 0.1 M PhN═P(OCH₃)₃ (PhTMI) after heating for 1 week.

### DETAILED DESCRIPTION OF THE INVENTION

It has been observed that storage of Li-ion cells containing LiPF₆-based electrolytes at temperatures above 60° C. results in a significant loss of its capacity and rate capability. A major cause of this capacity loss has been determined to be the decomposition of the electrolyte. Decomposition of Li-ion battery electrolytes has been observed previously as reported by S. E. Sloop, J. B. Kerr and K. Kinoshita, The 200^{th} meeting of the Electrochemical Society, San Francisco, Calif., September 2-7, Extended Abstract Number 105.

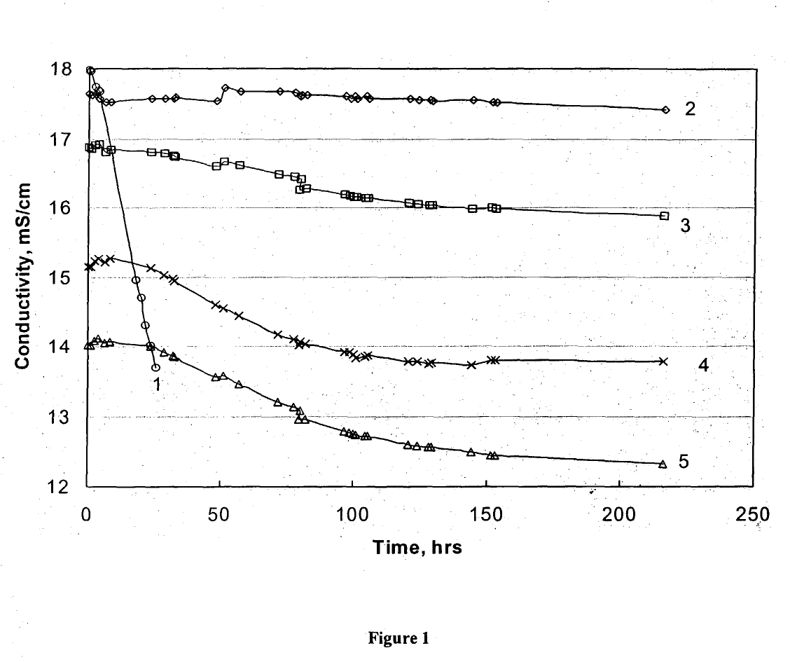

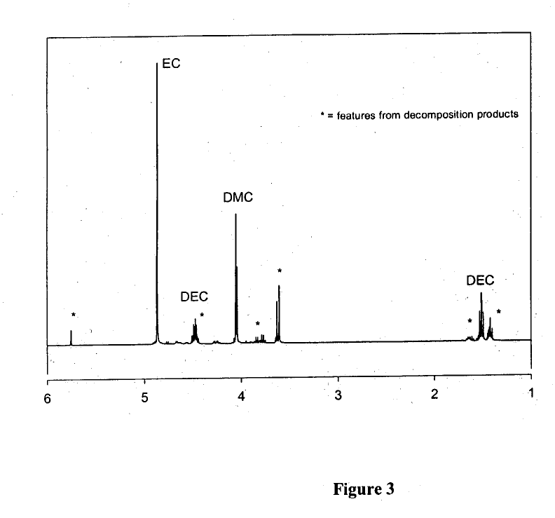

With reference to the drawings and particularly to FIGS. 1 and 3 thereof, a number of experiments were conducted to verify the decomposition of electrolytes composed of LiPF₆ solutions in organic carbonate solvents when stored at elevated temperatures, particularly at 85° C.

In one series of experiments, time dependent changes in the conductivities of LiPF₆ electrolyte solutions in carbonate solvents were monitored. For example, the conductivities of 1.0 M LiPF₆ in EC/DMC/DEC (1/1/1) were measured as a function of time at +85° C. as shown in Curve 1 of FIG. 1. The electrolyte solutions lost about 15-20% of their initial conductivity in one day's storage at 85° C. During one week of storage at 80° C., the solutions acquired a dark color.

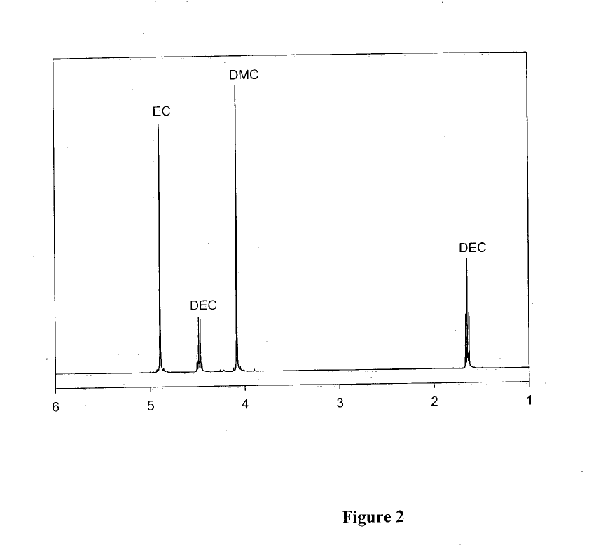

In a second series of experiments, the ¹H NMR spectra of the solutions were monitored as a function of storage time as illustrated in FIG. 3. A comparison of this spectrum with the spectrum in FIG. 2 indicates significant solvent decomposition. The new ¹H resonances in FIG. 3 for the stored solutions are consistent with the decomposition of the solvents to form the products ethyl fluoride, dimethyl ether, ethylmethyl ether, ethylfluoroformate, and diethyl ether.

The electrolyte decomposition is believed to occur via a combination of the following routes. In the first place, LiPF₆ decomposes starting at about 60° C. as shown in equation (1)

LiPF₆→LiF+PF₅ (1)

Being a strong Lewis acid, the PF₅ thus produced catalyzes the decomposition of the carbonate solvents, which are Lewis bases, or reacts with them.

In the second route, solvent decomposition is believed to be catalyzed by the trace amounts of water impurity present in the electrolyte. The water hydrolyzes the LiPF₆ and PF₅ present in the electrolyte as depicted in equations (2) and (3):

LiPF₆+H₂O→POF₃+2HF+LiF (2)

PF₅+H₂O→POF₃+2HF (3)

A detailed description of the most probable manner in which LiPF₆ interacts with the solvent leading to the formation of PF₅ and subsequent solvent decomposition is presented in the following equations.

LiPF₆+x solv→Li⁺(solv)ₓPF₆⁻ (4)

Li⁺(solv)ₓPF₆⁻→LiF+PF₅(solv)ₓ (5)

PF₅(solv)ₓ→product(s) (6)

The abbreviation solv in the above equations stands for a carbonate solvent molecule.

The POF₃ formed in equations (2) and (3) is also a Lewis acid which can complex with the solvents to form POF₃(solv)ₓ and cause solvent decomposition.

It has been found from equations (4)-(6) that a possible way to prevent the decomposition of carbonate solvents is with the use of an additive that forms a stable complex with either LiPF₆ (through Li⁺) or PF₅ or POF₃ or all three of these materials. Since Li⁺, PF₅ and POF₃ are Lewis acids, the desired agent (additive) to stabilize the electrolyte is a Lewis base.

It has been discovered in accordance with the invention that certain Lewis bases such as amines, for example, triethylenediamine(TEDA) and 2,2′-bipyridine (BIPY), phosphines, for example, triphenylphosphine (TPP) and tributylphosphine (TBP), and nitrogen-phosphorus bonded compounds such as hexamethoxycyclotriphosphazene ([N═P(OCH₃)₂]₃) (HMOPA), hexamethylphosphoramide (HMPA) and N-phenyl-P,P,P-trimethylphosphorimidate (PhTMI) added to the electrolyte, stabilize the electrolyte against thermal decomposition. The structural formulas of these additives follow:

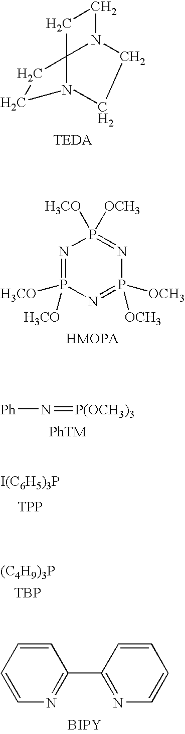

Thus, addition of about three weight percent of HMOPA to the electrolytes composed of LiPF₆ in organic carbonate solvents prevents the decomposition of these solutions stored at temperatures between 60 and 85° C. Without the presence of the HMOPA additive, the solutions undergo significant decomposition.

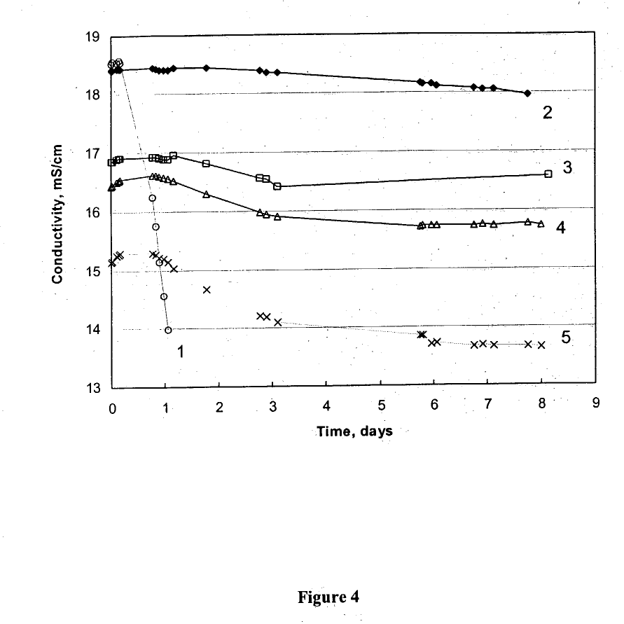

Strong evidence for the stabilization of electrolytes by HMOPA came from studies of the time dependent changes in the conductivities of LiPF₆ electrolyte solutions in carbonate solvents. For example the conductivities of 1M LiPF₆ solutions containing 3.0, 6.1, 9.1, and 11.9% by weight of HMPOA in EC/EMC (1/3), and 3.0, 6.0, 9.0, and 11.8% by weight of HMOPA in EC/DMC/DEC (1/1/1) were measured at +85° C. (see FIGS. 1 and 4). It is seen that HMOPA increases the thermal stability of the solutions. Thus, while the conductivity of the solutions without HMOPA loses about 15-20% of their initial conductivity in one day's storage at 85° C., the conductivity of the solutions containing 3% of this additive decreases very little; for example after one week of storage at the same conditions, the conductivity is 98-99% of the initial value. After storage at 85° C. for a week, the solutions with HMOPA remained transparent and acquired no color, whereas the solutions without HMOPA acquired a dark color after two to three hours of storage. It should be noted that a small amount of a white precipitate was observed in the solutions with 9 and 11.9% by weight of HMOPA in the EC/EMC solution.

The conductivity data above indicate that 3 weight percent (w/o) is probably the optimum amount of the HMOPA additive required to stabilize the electrolyte. The lower thermal stability of the solutions with higher content of HMOPA (e.g., 6, 9, and 12 w/o) than that of the solution containing 3 w/o of HMOPA can be explained in the following manner.

If the reaction between PF₅ and HMOPA is reversible,

xPF₅+HMOPA→(PF₅)ₓ.HMOPA (7)

then the concentration of free PF₅ is decreased when the concentration of HMOPA is higher. In turn, the reduction in the concentration of free PF₅ shifts equilibrium (5) to the right side forming the precipitate of LiF (see above), consuming the LiPF₆ and decreasing the conductivity. It thus appears that the best activity of HMOPA as an additive to thermally stabilize the electrolyte solutions is found at about three weight percent in solutions containing 1 molar LiPF₆. The preferred amount of HMOPA as an additive to stabilize LiPF₆ solutions in organic carbonate solvents is between 1.5 and 4 percent by weight of the solution.

Additional examples of thermal stabilization are illustrated by the following results of NMR experiments. The samples contained 1.0 M LiPF₆ in EC/DMC/DEC (1:1:1) with various Lewis bases at a concentration of about 0.1 M. The spectra shown are ¹H NMR spectra of the solvent mixture in the electrolyte. It should be noted that ³¹P and ¹⁹F NMR spectra were also acquired and supported the conclusions.

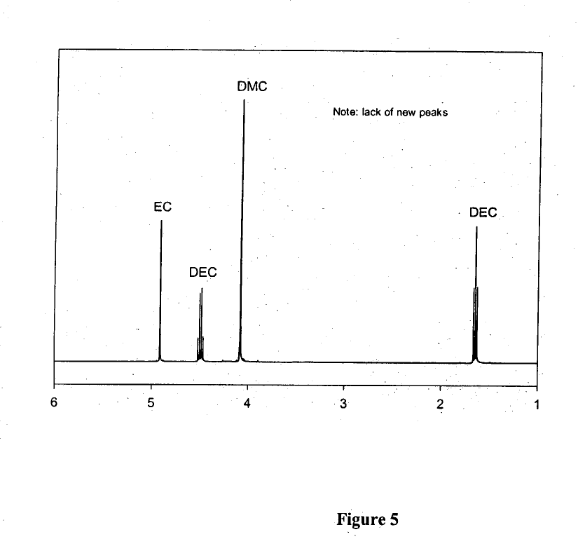

Thus the ¹H NMR spectrum of a solution of 1.0 M LiPF₆ in EC/DMC/DEC (1:1:1) with 3 weight percent (0.1 M) [NP(OCH₃)₂]₃ (HMOPA) was measured after heating at 85° C. for 2 months. As seen in FIG. 5, the spectrum indicated that the resonances characteristics of the carbonate solvents remained unchanged after the storage whereas the ¹H NMR spectrum of a solution without HMOPA showed extensive decomposition as shown in FIG. 3.

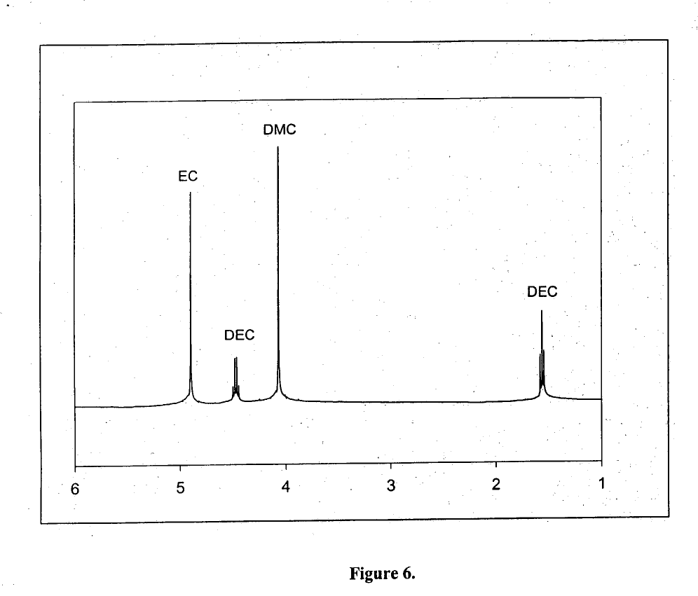

In another experiment, the ¹H NMR spectrum was taken of a solution of 1.0 M LiPF₆ in EC/DMC/DEC (1:1:1) with PhTMI (0.1 M) after heating at 85° C. for 1 week. As seen in FIG. 6, the spectrum showed that DMC and DEC exchange methoxy and ethoxy groups producing low concentrations (˜5%) of methylethylcarbonate (EMC) but there was no observed solvent decomposition as seen in solutions without PhTMI.

In another experiment, the ¹H NMR spectrum was taken of a solution of 1.0 M LiPF₆ in 1:1:1 EC/DMC/DEC with TEDA (0.1 M) after heating at 85° C. for 1 month. The spectrum showed that DMC and DEC exchange methoxy and ethoxy groups producing methylethylcarbonate (EMC) but there was no observed solvent decomposition as seen in solutions without TEDA.

From the results illustrated in the above examples, it is clear that the electrolytes disclosed herein, composed of LiPF₆ solutions in organic carbonate solutions containing a Lewis base additive or a mixture of Lewis base additives, are extremely valuable as thermally stable electrolytes for use in Li-ion batteries. The electrolytes of the invention provide excellent cycling and low temperature performance for Li-ion batteries in addition to thermal stability at temperatures as high as 85° C.

The performance of the HOMPA additive in Li-ion cells was demonstrated in the following seven ampere-hour nominal capacity cell test.

LiNi_{0.8}Co_{0.2}O₂ was used as the cathode material, and mesocarbonmicrobead (MCMB) graphite was used as the anode material in the 7 ampere-hour cell. The theoretical capacity of the cell was 7.65 ampere-hour (Ah). The cell was filled with a solution of 1.0 M LiPF₆ in EC/DMC/DEC (1:1:1) with 3 weight percent (0.1 M) [NP(OCH₃)₂]₃ (HMOPA). The cell was hermetically sealed in a stainless steel can.

The cell was cycled at different discharge rates while all the charges were performed in taper mode (an initial galvanostatic charging at the C/5 rate to 4.1 V followed by potentiostatic charging at 4.1 V while the current decayed to 50 μA). The cell cycling schedule was the following:

1. three formation cycles (one at the C/20 rate charge-discharge cycle followed by two C/10 rate cycles) at 25° C.;

2. nine cycles at 25° C. (three C/5 discharge, three C/2 discharge and three C-rate cycles);

3. 72-hour stand in the charged state at 25° C.;

4. nine cycles at −20° C. (three C/5, three C/2 and, three C rate discharges);

5. two recovery cycles at 25° C. (C/5 discharge rate);

The results of the cycling are presented in the following Table.

| | | 1M LiPF₆ in | |
|---|---|---|---|
| | | EC/DMC/DEC (1/1/1) | |
| | | No | With 3% |
| | | HMOPA | HMOPA |
| Initial | Charge(Ah) | 7.100 | 7.011 |
| | Discharge(Ah) | 6.952 | 6.890 |
| Recovered capacity after | Charge( Ah) | 6.566 | 6.571 |
| cycling at temperatures from | Discharge(Ah) | 6.541 | 6.568 |
| 25 to −20° C. | | | |

These data demonstrate the usefulness of the HMOPA additive in Li-ion cells.

The Lewis base additives of the present invention may also be useful to stabilize LiPF₆ containing electrolytes in solvents other than organic carbonates. These include ethers such as diethyl ether, glymes such as 1,2-dimethoxy ethylether and polyethyleneglycol dimethyl ethers, esters such as ethyl acetate, methyl acetate, methyl formate, organic nitriles such as acetonitrile, and sulfones such as dimethyl and diethyl sulfones.

The Lewis base additives suitable for stabilizing LiPF₆-containing electrolytes are not limited to the ones discussed above. A Lewis base is defined as a chemical compound having unpaired electrons capable of donating them to an electron acceptor compound (or a Lewis acid) such as PF₅. As a result, the Lewis base additives can be used to stabilize electrolytes containing salts other than LiPF₆ if they also produce Lewis acids upon their decomposition. Examples of such electrolytes include those containing lithium hexafluoroarsenate (LiAsF₆) and lithium tetrafluoroborate (LiBF₄).

It is understood that various other modifications are possible and can be made by those skilled in the art without departing from the scope and spirit of the invention.

What is claimed is:

1. A non-aqueous electrolyte for use in rechargeable Li-ion batteries comprising a solution of a lithium salt in a non-aqueous organic solvent containing a Lewis base additive.

2. A non-aqueous electrolyte according to claim 1 wherein said Lewis base additive is selected from the group consisting of amines, phosphines and nitrogen-phosphorus bonded compounds as well as mixtures thereof.

3. A non-aqueous electrolyte according to claim 2 wherein said Lewis base additive is an amine selected from the group consisting of triethylenediamine (TEDA) and 2,2′-bipyridine (BIPY) as well as mixtures thereof.

4. A non-aqueous electrolyte according to claim 2 wherein said Lewis base additive is a phosphine selected from the group consisting of triphenylphosphine (TPP) and tributylphosphine (TBP) as well as mixtures thereof.

5. A non-aqueous electrolyte according to claim 2 wherein said Lewis base additive is a nitrogen-phosphorus bonded compound selected from the group consisting of hexamethoxycyclotriphosphazene ([N═P(OCH₃)₂]₃) (HMOPA), hexamethylphosphoramide (HMPA) and N-phenyl-P,P,P-trimethylphosphorimidate (PhTMI) as well as mixtures thereof.

6. A non-aqueous electrolyte according to claim 2 wherein said lithium salt is selected from the group consisting of lithium hexaflurophosphate (LiPF₆), lithium hexafluoroarsenate(LiAsF₆) and lithium tetrafluoroborate (LiBF₄) as well as mixtures thereof.

7. A non-aqueous electrolyte according to claim 6 wherein said lithium salt is lithium hexaflurophosphate (LiPF₆).

8. A non-aqueous electrolyte according to claim 2 wherein said organic solvent is selected from the group consisting of organic carbonates, esters, ethers, glymes, organic nitriles, and sulfones as well as mixtures thereof.

9. A non-aqueous electrolyte according to claim 8 wherein said organic solvent is a cyclic organic carbonate selected from the group consisting of ethylene carbonate (EC), propylene carbonate (PC), triethylene carbonate (TEC), and isobutylene carbonate (IBC) as well as mixtures thereof.

10. A non-aqueous electrolyte according to claim 9 wherein said organic solvent is ethylene carbonate.

11. A non-aqueous electrolyte according to claim 8 wherein said organic solvent is an acyclic organic carbonate selected from the group consisting of dimethyl carbonate (DMC), diethyl carbonate (DEC) and ethylmethyl carbonate (EMC) as well as mixtures thereof.

12. A non-aqueous electrolyte according to claim 8 wherein said organic solvent is a compound of the general formula ROCOOR¹, where R and R¹ are the same or different alkyl groups.

13. A non-aqueous electrolyte according to claim 8 wherein said organic solvent is a mixture of the cyclic organic carbonate ethylene carbonate (EC) and one or more acyclic organic carbonates selected from the group consisting of dimethyl carbonate (DMC), diethyl carbonate (DEC), ethylmethyl carbonate (EMC), as well as compounds of the general formula ROCOOR¹, where R and R¹ are the same or different alkyl groups, and mixtures thereof.

14. A non-aqueous electrolyte of claim 4 wherein the said non-aqueous solvent is a mixture of the cyclic organic carbonates selected from the group consisting of ethylene carbonate (EC), propylene carbonate (PC), triethylene carbonate (TEC) and isobutylene carbonate (IBC) and one or more acyclic carbonates selected from the group consisting of dimethyl carbonate (DMC), diethyl carbonate (DEC), ethylmethyl carbonate (EMC), as well as compounds of the general formula ROCOOR¹, where R and R¹ are the same or different alkyl groups and mixtures thereof.

15. An electric current producing rechargeable Li-ion cell comprising an anode; a cathode; and a non-aqueous electrolyte comprising a solution of a lithium salt in a non-aqueous organic solvent containing a Lewis base additive.

16. An electric current producing Li-ion cell according to claim 15 wherein said Lewis base additive is selected from the group consisting of amines, phosphines, nitrogen-phosphorus bonded compounds and mixtures thereof.

17. An electric current producing Li-ion cell according to claim 16 wherein said Lewis base additive is an amine selected from the group consisting of triethylenediamine (TEDA) and 2,2′-bipyridine (BIPY) and mixtures thereof.

18. An electric current producing Li-ion cell according to claim 16 wherein said Lewis base additive is a phosphine selected from the group consisting of triphenylphosphine (TPP) and tributylphosphine (TBP) and mixtures thereof.

19. An electric current producing Li-ion cell according to claim 16 wherein said Lewis base additive is a nitrogen-phosphorus bonded compound selected from the group consisting of hexamethoxycyclotriphosphazene ([N═P(OCH₃)₂]₃) (HMOPA), hexamethylphosphoramide (HMPA), N-phenyl-P,P,P-trimethylphosphorimidate (PhTMI) and mixtures thereof.

20. An electric current producing Li-ion cell according to claim 16 wherein the said anode consists of a lithium intercalating compound.

21. An electric current producing Li-ion cell according to claim 20 wherein the said lithium intercalating compound is a carbonaceous material

22. An electric current producing Li-ion cell according to claim 16 wherein the said cathode is a lithium intercalating transition metal compound.

23. An electric current producing Li-ion cell according to claim 22 wherein said lithium intercalating transition metal compound is selected from the group consisting of LiCoO₂; LiNiO₂; LiNi₁₋ₓCoₓO₂ where x is 0.3<x<1.0; LiMn₂O₄; LiV₂O₅; LiMₓN₁₋ₓO₂, where M and N are transition metals and x has a value between zero and one; LiFePO₄; LiCrS₂; and LiVS₂.

24. An electric current producing Li-ion cell according to claim 16 wherein said lithium salt is selected from the group consisting of lithium hexaflurophosphate (LiPF₆), lithium hexafluoroarsenate(LiAsF₆) and lithium tetrafluoroborate (LiBF₄) as well as mixtures thereof.

25. An electric current producing cell Li-ion according to claim 16 wherein said organic solvent is selected from the group consisting of organic carbonates, esters, ethers, glymes, organic nitriles and sulfones as well as mixtures thereof.
